(19) United States
(12) Patent Application Publication
(10) Pub. No.: US 2009/0228395 A1
(43) Pub. Date: Sep. 10, 2009

(54) METHOD FOR DISSEMINATING DRM CONTENT

(76) Inventors: Susan Wegner, Berlin (DE); Sven Wischnowsky, Berlin (DE); Bernhard Feiten, Berlin (DE); Gerd Foth, Berlin (DE); Jens Kroll, Berlin (DE); Florian Koelln, Berlin (DE); Peter Hofmann, Berlin (DE); Hauke Witt, Wahlstorf (DE)

Correspondence Address: DARBY & DARBY P.C., P.O. BOX 770, Church Street Station, New York, NY, 10008-0770, US

(21) Appl. No.: 11/913,875

(22) PCT Filed: Apr. 6, 2006
(86) PCT No.: PCT/DE06/00613

§ 371 Date: Jun. 24, 2008

(30) Foreign Application Priority Data
May 11, 2005 (DE) 10 2005 022 834.8

(51) Int. Cl. G06F 21/00

(52) U.S. Cl. 705/59

(57) ABSTRACT

Method for disseminating digital content that is secured by Digital Rights Management (DRM), the digital content being encrypted and playback of the digital content being linked to a license that is provided with a digital key including associated attributes that regulate at least one of a type, a scope and a duration of a permissible utilization of the digital content, including: generating a DRM ticket including an unambiguous destination address on a DRM server contactable via a computer network, the DRM ticket configured to enable a user in possession of the DRM ticket to download, at the destination address, a first license onto a device configured to play digital content; making the DRM ticket available to a buyer of the first license; and generating the first license based on rights coupled to the DRM ticket at a moment of a download of the first license onto the DRM server, the rights being stipulated by a content provider when the DRM ticket is generated.

### CROSS REFERENCE TO RELATED APPLICATIONS

This is a U.S. national phase application under 35 U.S.C. § 371 of International Patent Application No. PCT/DE2006/000613, filed Apr. 6, 2006, and claims benefit of German Patent Application No. 10 2005 022 834.8, filed May 11, 2005. The International application was published in German on Nov. 16, 2006 as WO 2006/119722 A1 under PCT Article 21(2).

### FIELD

The present invention relates to a method for disseminating digital DRM (Digital Rights Management) content. It preferably refers to the dissemination of such content, especially media content, via the Internet, although it is not restricted to this.

### BACKGROUND

In view of the increasing dissemination of media content and other digital content via broadband networks, efforts to secure and protect the rights of copyright holders or else of those involved in the creation of the content and its distribution have acquired great significance. In this context, the main objective is to prevent widespread unpaid downloading and misuse in the form of illegal copies as well as illegal commercial dissemination.

The problem of misuse of digital content and of the non-observance of the rights to it that exist has become particularly virulent because of the development of refined compression methods that permit high compression rates and because of the concurrent growing availability of broadband technologies such as DSL. Consequently, more and more techniques have recently been developed with the aim of protecting the above-mentioned rights or of preventing illegal misuse, especially of media content, despite widespread dissemination, for example, via the Internet. Such techniques fall under the umbrella term “digital rights management”. In this context, providers take measures that allow them to influence the scope and, if applicable, the channels of dissemination of the content. This is done by encrypting the content. According to the state of the art, the user of such a protected digital content loads the content as well as the key onto a device suitable for playing the content. Generally by making use of a so-called token, the user acquires—as a rule by a download from a server that manages the rights, i.e. a so-called DRM server of a distributor—a license in the form of a key and right attributes coupled to it which regulate the type, scope and/or duration of permissible utilization of the content. Here, the key is linked to the device-specific hardware and/or software of the particular device to which the key is transmitted. In this manner, the utilization of that particular content is permanently linked to that specific device.

On the other hand, devices for playing digital content, particularly media content, are available nowadays in a wide array of types and forms. The assortment ranges from cellular phones to laptops and PCs all the way to devices stemming from the convergence of computation technology and communications technology or of computation technology and consumer electronics. Consequently, users certainly have the need to make use of the acquired digital content on different devices. This, however, is not possible with the solutions known so far for the implementation of DRM. Moreover, it cannot be ruled out that, in the future, such content will be disseminated almost exclusively by the above-mentioned modalities, so that conventional distribution channels such as, for instance, sellers of music CDs or videos, will lose their significance. Aside from that, it is conceivable that new possibilities might also open up for these conventional distribution channels through the utilization of DRM, for instance, in that customers can themselves compile the content of a CD in such stores and their utilization is regulated by DRM, for example, in order to prevent duplication of any desired number of copies having the same quality. In this context, with the conventional techniques described above, it becomes very difficult for buyers of content to acquire such content for a third party, for instance, as a gift, if the corresponding licenses for utilization of the content are right from the start associated exclusively with a specific device. Thus, it is not possible for the person giving the gift to play the purchased content on his own device so as to acquire an impression of the content and to subsequently give it to someone else as a gift.

Moreover, the DRM systems employed so far involve various licenses of a proprietary nature which are sold by distributors for the utilization of such digital content, in other words, the utilization of the content by the licenses is possible exclusively by using the hardware and/or software provided by a given distributor. This means that the use of DRM content is certainly not very convenient for users.

### SUMMARY

An aspect of the present invention is to provide a solution that allows a more flexible utilization of digital content that has been secured using DRM.

In an embodiment, the present invention provides a method for disseminating digital content that is secured by Digital Rights Management (DRM), the digital content being encrypted and playback of the digital content being linked to a license that is provided with a digital key including associated attributes that regulate at least one of a type, a scope and a duration of a permissible utilization of the digital content. The method includes: generating a DRM ticket including an unambiguous destination address on a DRM server contactable via a computer network, the DRM ticket configured to enable a user in possession of the DRM ticket to download, at the destination address, a first license onto a device configured to play digital content; making the DRM ticket available to a buyer of the first license; and generating the first license based on rights coupled to the DRM ticket at a moment of a download of the first license onto the DRM server, the rights being stipulated by a content provider when the DRM ticket is generated.

### BRIEF DESCRIPTION OF THE DRAWINGS

Aspects of the present invention will now be described by way of exemplary embodiments with reference to the following drawings, in which:

FIGS. 1a and 1b are a flowcharts showing the sequences during the utilization of a DRM ticket, according to an exemplary embodiment of the present invention;

FIGS. 2a and 2b are flowcharts showing the sequences during the purchase of a DRM ticket, in depictions corresponding to FIGS. 1a and 1b.

### DETAILED DESCRIPTION

The proposed method serves to disseminate digital content that is secured by DRM, whereby the content is encrypted and its playback is linked to a license. The license is configured as a digital key and linked to attributes, so-called rights, that regulate the type, scope and/or duration of the permissible utilization of the content.

According to an exemplary embodiment of the present invention, a digital ticket (hereinafter also referred to as a DRM ticket) that constitutes an unambiguous destination address on a server (hereinafter also referred to as a DRM server) that can be contacted via a computer network is made available to the buyer of licenses for content secured by DRM. At this address, the user in possession of the ticket—this person does not necessarily have to be the buyer of the content in question—can download licenses onto a device to be used to play the content. These licenses are generated on the basis of rights coupled to the DRM ticket at the moment when they are requested through the utilization of the DRM ticket, whereby the applicable rights are stipulated by the content provider within the scope of the generation of the DRM ticket. Here, the generation of the ticket—which is preferably done using a random number in conjunction with a hash algorithm—can take place on the DRM server itself, or else the ticket is generated on a system of the content provider and transmitted to the DRM server, that is to say, to the corresponding destination address set up there, to which the rights coupled with the DRM ticket are transmitted in the form of appropriate attributes. A license as such that is generated later on when the DRM ticket is used is then supplied as a device-specific license with appertaining keys for decrypting the DRM content, in other words, it is transmitted to a device suitable for playing the content.

A difference from the state of the art, as can be seen, lies in that fact that the buyer at first only receives the licenses indirectly as a digital ticket, namely, as a forgery-proof address that makes reference to an address on a server, namely, the DRM server. This is where, when the DRM ticket is used later on, licenses can be obtained as device-specific licenses. Therefore, in comparison to the DRM systems known from the state of the art, a sort of additional instance is implemented by which licenses can be issued more flexibly in terms of the recipient or of the devices used by the recipient, so that the content can be disseminated more flexibly, even independently of the actually underlying DRM system of the party issuing the utilization rights. It is clear that this makes it possible for a buyer of DRM content to transfer these licenses for utilization to a third party by providing the appropriate address (DRM ticket), for example, to relatives or friends or by making it available to them in some other way. Thus, the buyer can give the utilization of the content as a gift to relatives or friends by giving them the ticket he has acquired with the applicable rights and thus with the licenses to be generated at the address indicated on the ticket. The appertaining rights are defined by the distributor of the licenses during the generation of the ticket. The destination address indicated on a DRM ticket according to the invention is preferably the URL of an Internet site maintained by the DRM server that can be contacted via the Internet.

In an exemplary embodiment of the method according to the present invention, for purposes of management and invoicing within the scope of the generation of the DRM ticket with the coupled rights for the utilization of specific digital content, the content provider transmits a content ID and a utilization ID as well as, optionally, a shop ID, to the destination address of the DRM server indicated on the DRM ticket.

The DRM ticket can be configured as a text file that can be stored on a device of the buyer and/or of a user of the content, or else as a URL that is written as a bookmark directly into a browser that can be executed on the device by the source providing the digital ticket.

According to an advantageous embodiment, however, one or more digital tickets that provide an entitlement to use DRM content are managed in a ticket box. The latter is configured in the form of a database that is maintained on a server that can be contacted via a computer network, whereby a user of the DRM ticket authenticates himself to the ticket box in order to be able to use the ticket. Preferably, said server is the DRM server itself. Then, for all of the digital contents to be played utilizing the method, all that the user has to do is to store, for example, in his browser, only one address or URL at which all DRM tickets are managed for him, whereby the user, upon selecting a ticket, is redirected to the address indicated by the DRM ticket so that he can use the ticket.

The method presented here, as already elaborated upon, implements a level above the independent and generally proprietary DRM systems offered so far by various providers and operators. Here, it is possible for the destination addresses used on the DRM server for the execution of the method to represent DRM tickets of various content providers for purposes of generating licenses of one or several license issuers.

The DRM tickets according to an exemplary embodiment of the present invention are preferably distributed via online shops, whereby a purchased DRM ticket is issued to the buyer via the Internet. Here, the ticket is transmitted via a download to a device of the buyer or into the above-mentioned ticket box.

Another possibility is the distribution of the DRM ticket via removable storage media. The DRM tickets are then managed on the appertaining removable storage medium in a device of the buyer or of a user who is in possession of said medium, or else they are transmitted from the removable storage medium to a memory of the device for management purposes. The use of the ticket box, however, is also possible for this distribution modality. In this case, the DRM ticket or tickets are then transmitted to a ticket box via an upload from the removable storage medium by a device equipped with Internet access or with the possibility for such.

In an exemplary embodiment of the method according to the present invention, the DRM content is accompanied by an encrypted URL which, if a user's terminal device that is intended to play the content does not have the licenses that entitle utilization of the content, can be automatically contacted by this terminal device. At this URL, the user of the terminal device has the possibility of working with a menu to purchase a DRM ticket or to access a DRM ticket managed in a ticket box.

Preferably, the validity of the DRM ticket expires after a certain time. This is useful, for example, in order to avoid that tickets that have not been used over a prolonged period of time still have to be kept on the DRM server in the form of a continuously growing number of URLs, but optionally also in order to prevent attempts at manipulation. Another possible option is to stipulate for a given DRM ticket a maximum number of licenses that can be generated for downloading purposes.

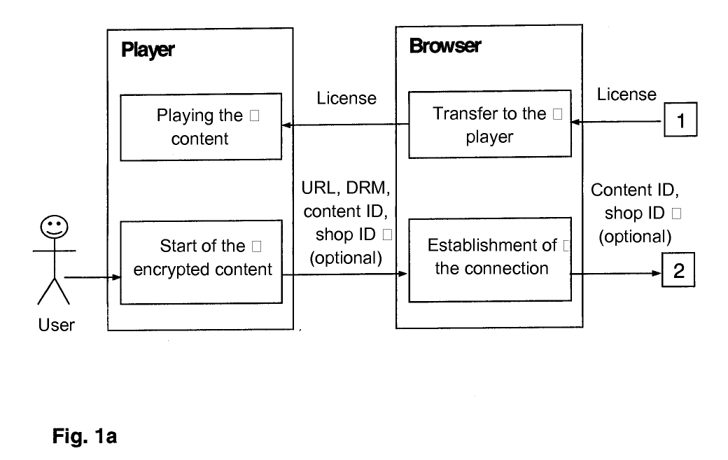

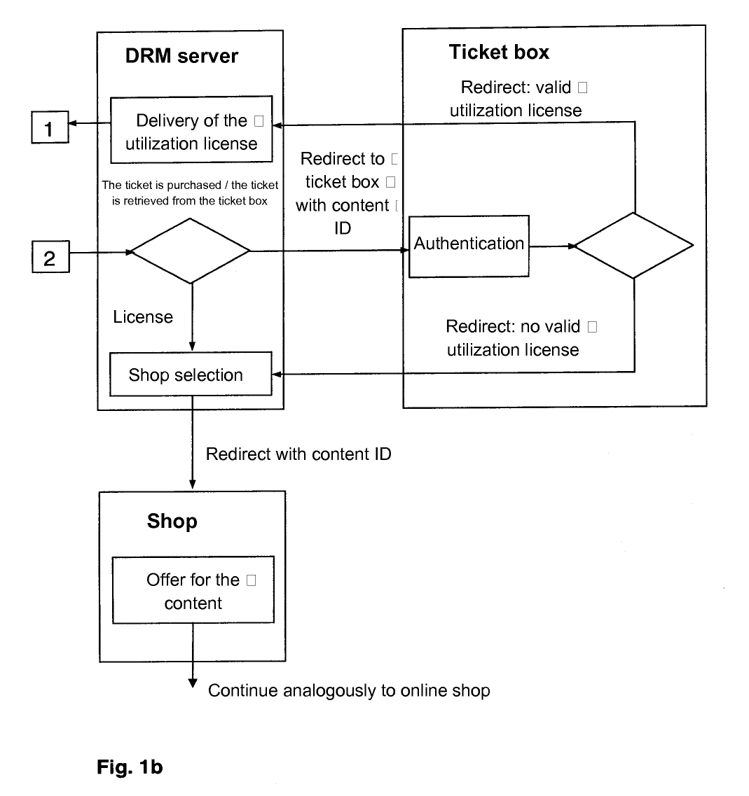

FIGS. 1a and 1b show the sequences during the utilization of a DRM ticket. According to FIGS. 1a and 1b, the sequence of the utilization of such a ticket is as follows: on a suitable device, for instance, an MP3 player, the user starts a DRM content, in other words, for example, an encrypted song. The hardware and software of the player checks whether the device contains the appropriate license for playing the selected digital content. If this is the case, the content, in the example selected here the song, can be played in accordance with the stipulations of the license present in the device or in accordance with the rights granted by the license. Otherwise, the player, which is equipped with Internet access or with the possibility for such, reads out a URL encrypted in the content and uses this URL to establish a connection to a server via the Internet. The establishment of the connection and the menu-driven communication with the server are done by a browser supported by the player. In the sense of the invention, the server is the DRM server itself or a server by which the DRM server is contacted as a function of the selection made by the user via the menu. Preferably, the software for the menu-driven communication, as in the example shown, is likewise kept on the DRM server, that is to say, a URL on the DRM server is directly contacted by the above-mentioned player.

After the connection to the DRM server has been established, the user can work with a menu to decide whether he wants to purchase a DRM ticket or whether he wants to use a previously bought ticket that is being managed in a ticket box. By a DRM ticket that he may have bought himself or that a third party may have bought and that is in his possession, he can then acquire—as in the example, directly or via a link to another server of the content provider—a license generated at this moment for playing the content he has selected. As is shown in the example, the ticket box is preferably managed on the DRM server itself. Irrespective of the number and type of tickets managed in the ticket box, that is to say, addresses or URLs, all that the user has to know and contact is the address of the ticket box so that, following an authentication procedure, he can access the digital ticket stored there.

For example, when it comes to the access possibilities to the Internet, the user obtains access to a digital ticket that is already being kept on the DRM server in the ticket box within the scope of a login operation, in other words, an authentication procedure. The DRM ticket that the user has bought himself or that has been given to him and is optionally being managed in the ticket box, has a period of validity that can be stipulated by the content provider as a function of the fee structure for the purchase the ticket. As long as the ticket is valid, the user can employ various devices in order to download licenses to utilize the content, via the DRM ticket or via the address indicated on the ticket, in this example an address on the DRM server. These licenses are then transmitted as device-specific keys to the particular device used for the download. Here, the licenses can be utilized in accordance with the rights contained in them and on the basis of the conditions stipulated for playing the content. The content can be audio data, video data or other data without media content. The appertaining license then regulates the rights granted for the utilization of the content in question, for instance, playing, viewing or printing. If the user attempts to access a DRM ticket in the ticket box but if no more tickets are stored there that are valid for him, he is redirected to an Internet site where tickets can be purchased.

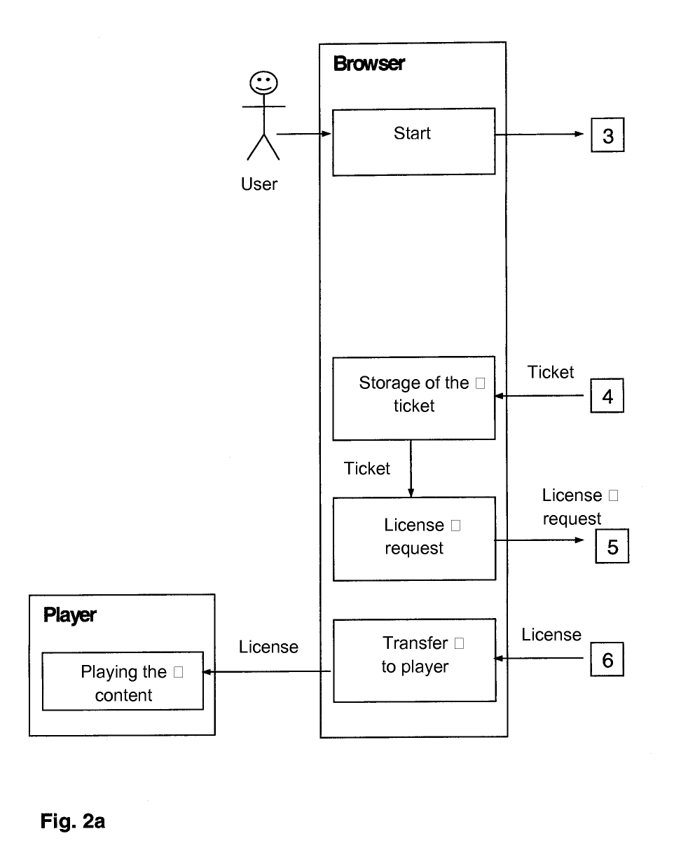

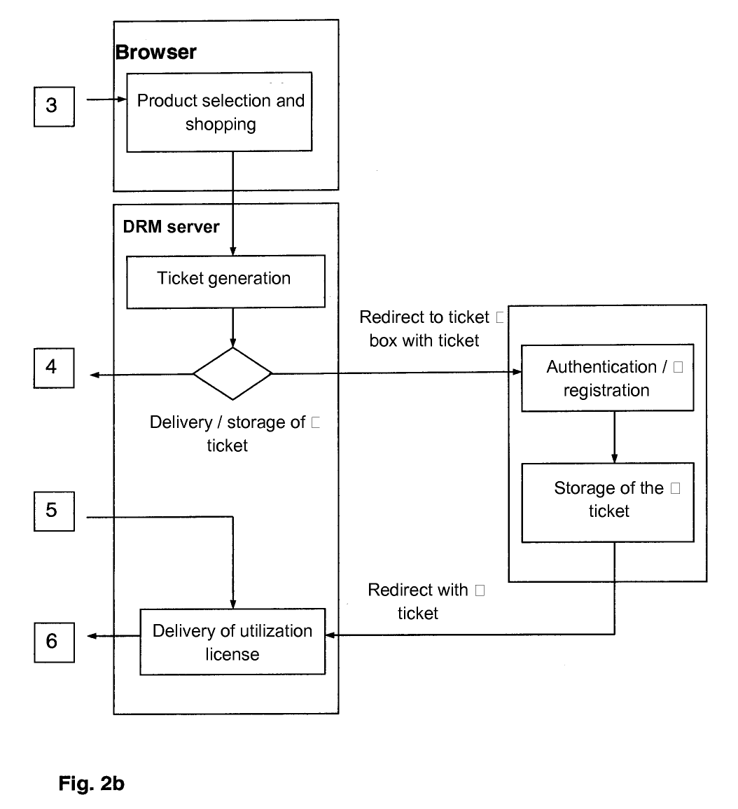

FIGS. 2a and 2b show the sequences during ticket purchasing. In the example, the acquisition of a ticket is done at an online shop. The user contacts the online shop via a browser. Here, he selects a product for which he would like to buy a digital or DRM ticket. After the purchase, the ticket is delivered to him in the form of an unambiguous, forgery-proof URL that is generated by employing a random number and a hash algorithm. In this context, the user has the option of storing the ticket himself on a terminal device suitable for this purpose or of having it managed in a ticket box, preferably on the DRM server. In the former case, he himself is responsible for managing the ticket. In contrast, the ticket box offers the advantage that there, the ticket is protected against accidental deletion or theft. A license linked to the DRM ticket is generated when the URL of the DRM server is contacted by the digital ticket, and it is then transmitted, together with the key needed to decrypt DRM-secured content, to the device used for the connection to the DRM server. For management purposes, within the scope of the generation of the DRM ticket with the rights coupled to it, a content ID and a utilization ID are transmitted by the online shop to the DRM server. Furthermore, as an option, a shop ID is also transmitted for purposes of invoicing between the operator of the DRM server on the one hand and the content provider or the distributor who issues the licenses on the other hand. Later on, by the content ID, a license requested through the use of the DRM ticket for a certain content is delivered to the user, said license being transmitted to the device used to play the content in question. Then, the license is once again a device-specific license. However, it can be clearly seen that, owing to the superordinated plane of the transmittable digital ticket, licenses that, in and of themselves, are device-specific licenses, can be utilized by various users on different devices.

As in the above-mentioned example, the DRM tickets are preferably sold or bought online. Naturally, it is also possible to provide the appertaining URL to the customer via other modalities, for instance, via removable storage media such as a CD or a DVD. The same applies to digital DRM content, whose distribution, when it comes to the technical modalities employed for this purpose, is fundamentally independent of the distribution of the licenses required for its utilization.

In this context, aside from the modality of online transmission, the digital content can also reach the playing device of the user via a shop, via superdistribution, via a CD or a similar method. Typical playing devices are PCs, laptops, PDAs, MDAs, MP3 players, cell phones or similar devices with a digital memory and the capability of loading digital content.

1-14. (canceled)

15. A method for disseminating digital content that is secured by Digital Rights Management (DRM), the digital content being encrypted and playback of the digital content being linked to a license that is provided with a digital key including associated attributes that regulate at least one of a type, a scope and a duration of a permissible utilization of the digital content, the method comprising:
generating a DRM ticket including an unambiguous destination address on a DRM server contactable via a computer network, the DRM ticket configured to enable a user in possession of the DRM ticket to download, at the destination address, a first license onto a device configured to play digital content;
making the DRM ticket available to a buyer of the first license; and
generating the first license based on rights coupled to the DRM ticket at a moment of a download of the first license onto the DRM server, the rights being stipulated by a content provider when the DRM ticket is generated.

16. The method according to claim 15, wherein the destination address is the URL of an Internet site maintained by the DRM server that is contactable via the Internet.

17. The method according to claim 15, wherein the generating the DRM ticket is performed using a random number in conjunction with a hash algorithm.

18. The method according to claim 15, further comprising, for purposes of management and invoicing within the scope of the generation of the DRM ticket with the coupled rights for the utilization of specific digital content, transmitting, by the content provider, at least one of a content ID, a utilization ID and a shop ID, to the destination address of the DM server included in the DRM ticket.

19. The method according to claim 15, wherein the DRM ticket is configured as a text file that is storable on a device of at least one of the buyer and of the user of the content, or as a URL that is written as a bookmark directly into a browser that can be executed on the device by a source generating the DRM ticket.

20. The method according to claim 15, further comprising:
managing the DRM ticket in a ticket box configured as a database maintained on a second server contactable via the computer network, whereby the user of the DRM ticket authenticates himself to the ticket box in order to be able to use the ticket.

21. The method according to claim 15, further comprising:
managing the DRM ticket in a ticket box configured as a database maintained on the DRM server, whereby the user of the DRM ticket authenticates himself to the ticket box in order to be able to use the ticket.

22. The method according to claim 15, wherein the destination address represents DRM tickets of various content providers for generating licenses of one or several license issuers.

23. The method according to claim 15, further comprising distributing the DRM ticket via an online shop, whereby a purchased DRM ticket is transmitted via the Internet to a ticket box or within the scope of a download to a device of the buyer.

24. The method according to claim 15, further comprising distributing the DRM ticket via a removable storage medium, whereby the DRM ticket is managed on the removable storage medium in a device of the buyer or of a user that is in possession of the medium, or transmitting the DRM ticket from the removable storage medium to a memory of the device of the buyer for management purposes.

25. The method according to claim 15, further comprising distributing the DRM ticket via a removable storage medium, whereby the DRM ticket is transmitted by a device of the buyer or of the user that is in possession of the medium via an upload from the removable storage medium to a ticket box that manages the DRM ticket.

26. The method according to claim 23, wherein the content is accompanied by an encrypted URL which, if the device does not have the license, is configured to be automatically contacted by the device, and at the URL, the user of the terminal device may use a menu to purchase the DRM ticket or to access the DRM ticket managed in a ticket box.

27. The method according to claim 15, wherein the DRM ticket expires after a time period.

28. The method according to claim 15, further comprising, stipulating, for a given DRM ticket, a maximum number of licenses that can be generated for downloading purposes.
